(19) United States
(12) Patent Application Publication
(10) Pub. No.: US 2008/0320545 A1
(43) Pub. Date: Dec. 25, 2008

(54) System and method for providing audio-visual programming with alternative content

(76) Inventor: Richard T. Schwartz, Chicago, IL (US)

Correspondence Address: PATTI, HEWITT & AREZINA LLC, ONE NORTH LASALLE STREET, 44TH FLOOR, CHICAGO, IL, 60602, US

(21) Appl. No.: 11/821,465

(22) Filed: Jun. 22, 2007

(51) Int. Cl. H04N 7/16

(52) U.S. Cl. 725/135; 725/141

(57) ABSTRACT

A system for presenting audio-video programming with alternative content comprises a first input port for receiving a first signal containing at least one audio-video program, the at least one audio-video program having at least one default component associated therewith and a second input port for receiving a selected alternative content stream, the selected alternative content stream selected from a plurality of available alternative content streams. The system further comprises a first output port for transmitting a modified audio-video program to an output device, and at least one controller in communication with the first input port, the second input port and the first output port. The at least one controller is operative to (i) synchronize the at least one audio-video program and the selected alternative content stream to form the modified audio-video program and (ii) transmit the modified audio-video program via the first output port.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to audio-visual programming, and methods for delivering audio-visual content, and more particularly, to systems and methods for providing audio-visual programming with alternative or supplemental audio, video, textual or graphic content.

### BACKGROUND OF THE INVENTION

Since the advent of television, viewers have been able to enjoy audio-visual broadcasts in the comfort of their homes. Broadcasting of audio-visual programming expanded from aerial antenna transmission to other forms of transmission including cable television providers and satellite televisions providers. Moreover, technology evolved to permit the recording and playback of audio-video programming on a variety of different medias, including video cassettes, digital video discs (DVD), and digital video recorders/players (DVR). Recording equipment such as DVRs allow users to watch programming at a custom speed, for example, bypassing commercials and advertising. Moreover, such equipment permits time shifting by allowing viewers to rewind, review, or record programming for future playback. Systems for receiving and displaying audio-video programming, such as set top boxes, and AV receivers, permitted viewers to receive a variety of broadcast programming and display or output such programs to a variety of output devices, such as televisions.

Traditionally, audio-video programming received by such systems arrived in a preformatted or pre-produced manner. In other words, programming such as television shows and films, would be broadcast to such systems as configured and produced. The output devices would receive the audio-video programming as it was broadcast from the input source, or provider. Although such traditional program receiving systems offered options via on screen menus, and the like, the options offered were limited to formatting, channel selection, audio preferences (treble, bass, tone, balance, etc.), while the content or programming displayed by such systems remained unaltered.

One problem that arises with such traditional systems is that the variety of content available to a viewer of the system is limited to the audio-video content broadcast by the input source, or provider. In other words, the components of the audio-video programming, such as audio, video, and graphics components, are pre-configured and pre-produced, and broadcast to the viewer who is able to experience the programming only in the format it was received. Another problem that arises is that such systems fail to take into consideration the various differences in viewership of the broadcast programming, and offer only a “one size fits all” solution. Yet another problem of traditional systems is that only limited customization options are offered. Yet another problem that exists is that such traditional systems offer no abilities to tailor programming content to viewers with particular skill levels, expertise, preferences, interests and needs. Yet another problem that exists is that viewers of audio-video programs received on such traditional systems are restricted to a program producer's selection of audio, video, graphical, and textual elements. Therefore, a need exists for system which allows a viewer to experience improved and enhanced content based upon a viewer's preferences to create a more compelling viewing experience. The present invention is directed to solving these and other problems.

### SUMMARY OF THE INVENTION

According to one aspect of the present invention, a system for presenting audio-video programming with alternative content comprises a first input port for receiving a first signal containing at least one audio-video program, the at least one audio-video program having at least one default component associated therewith and a second input port for receiving a selected alternative content stream, the selected alternative content stream selected from a plurality of available alternative content streams. The system further comprises a first output port for transmitting a modified audio-video program to an output device, and at least one controller in communication with the first input port, the second input port and the first output port. The at least one controller is operative to (i) synchronize the at least one audio-video program and the selected alternative content stream to form the modified audio-video program and (ii) transmit the modified audio-video program via the first output port.

According to another aspect of the invention, a method for modifying and presenting audio-video content comprises receiving a first signal containing at least one audio-video program, the at least one audio-video program having at least one default audio track associated therewith, and receiving a selection of an alternative content stream, the selected alternative content stream selected from a plurality of available alternative content streams. The method further comprises receiving the selected alternative content stream, synchronizing the at least one audio-video program and the selected alternative content stream to form a modified audio-video program, transmitting the modified audio-video program to an output device, and presenting the modified audio-video program via the output device.

According to yet another aspect of the invention, a method for modifying audio-video content comprises receiving a first signal containing at least one audio-video program, the at least one audio-video program having at least one of a video component, an audio component, a graphical component and a textual component, and receiving and storing on a server a plurality of available alternative content streams. Each of the alternative content streams is associated with the at least one audio-video program. Each of the alternative content streams has at least one of a video component, an audio component, a graphical component and a textual component. The method further comprises selecting an alternative content stream from the plurality of available alternative content streams, receiving the selected alternative content stream, synchronizing the at least one audio-video program and the selected alternative content stream to form a modified audio-video program, and transmitting the modified audio-video program to an output device.

According to yet another aspect of the invention, a computer readable storage medium is encoded with instructions for directing a gaming system to perform the above methods.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a diagram of a traditional audio-visual programming delivery system;

FIG. 2 is a diagram of a system for providing audio-visual programming with alternative content;

FIG. 3 is a diagram of a data system for use with the system of FIG. 2;

FIG. 4 is a flow chart of a method of modifying and presenting audio-video content; and

FIG. 5 is a flow chart of a method of modifying audio-video content.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

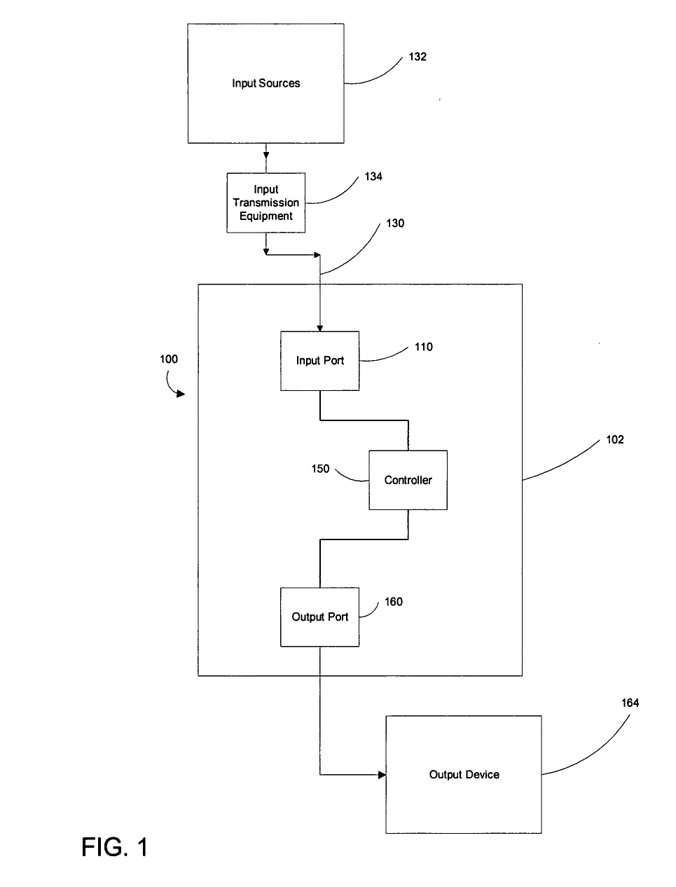

Referring to FIG. 1, a traditional audio-video programming system 100 is depicted. The system 100 includes at least one input port 110, a controller 150, and at least one output port 160. The input port 110 receives audio-video programming from one or more input sources 132, such as a cable television provider, a satellite television provider, or a media device such as a DVD player. The input sources 132 deliver a first signal 130 of audio-video programming to the system 100 via input transmission equipment 134, which can include cabling, routers, switching equipment, wireless or satellite transmitters and receivers, and other equipment which conveys the first signal 130 from the input source 132 to the system 100. The input transmission equipment 134 utilized may be generic, or may be specific hardware necessary for the relevant forms of input sources 132 in use.

Once the first signal 130 is received by the system 100, it is processed by the controller 150 and broadcast to an output device 164 via an output port 160. The first signal 130 contains one or more channels of audio-visual programming such as television programs, films, audio performances, etc. As used herein, “audio-visual” or “audio-video” means programming which has at least an audio component, a video component, or both. Thus, the term can signify an audio performance only, a video performance only, or a combined performance having both video and audio components (and perhaps other components as well, such as graphical and/or textual components). Thus, the first signal 130 delivers a program as produced by an original source 132 which is processed by the controller 150, and presented on an output device 164 such as a television, a monitor, a display, audio speakers, etc. The output port 160 may be one or more varieties of physical ports that are appropriate for connecting the output device 164, such as a port for receiving various types of audio cables and/or video cables. The controller 150 may perform any variety of functions for processing the first signal 130, such as selecting programming from various channels of the first signal 130 to be output to the out device 164. The components of the system 100 are housed within a housing 102.

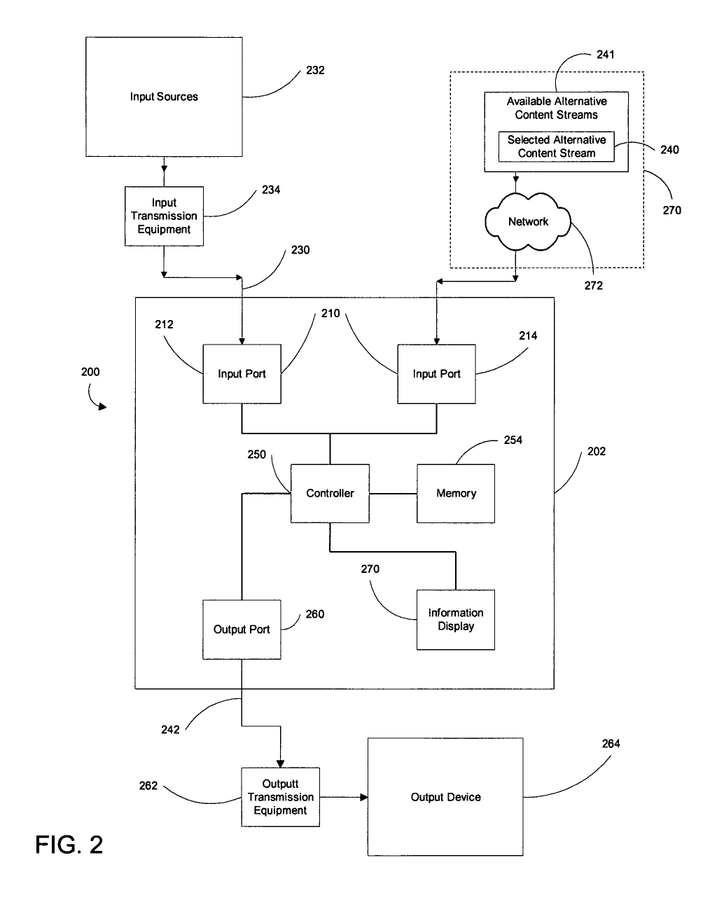

Turning to FIG. 2, an improved system 200 for presenting audio-video programming with alternative content is depicted. The system 200 includes a housing 202, a plurality of input ports 210, at least one output port 260, and a controller 250. In an embodiment, the various components of the system 200 may be housed within the housing 202, or alternatively may be dispersed in various locations, and in communication with one another through one or more wired or wireless communication methods. In the embodiment shown in FIG. 2, a plurality of the components are housed within the housing 202.

The plurality of input ports 210 includes at least a first input port 212 and a second input port 214. The first input port 212 is configured so as to receive a first signal 230 containing at least one audio-video program, but may contain any number of channels of audio-video programming. The first input port 212 may be any form of analog or digital input port for receiving audio-video programming from an input source 232 or audio-video broadcaster, such as a cable television or satellite television provider. For example, the first input port 212 may be an RF cable input, an S-video port, an HDMI port, a DVI port, an RCA port, a digital coaxial cable port, a Y/Pr/Pb component video port, a VGA port, a fiber optic port, a D-sub port, a ViVo port, an aerial antenna, a digital audio port or a D-connector port. Any other port for receiving audio-video programming may be utilized, including hard wired connections, physical ports, and wireless transceiver ports.

One or more input sources 232 transmit one or more audio-video broadcasts via at least a first signal 230, which are received by the system 200 via the first input port 212. The sources 232 may include, but are not limited to, a cable television broadcast, a digital satellite broadcast, a satellite television broadcast, an aerial antenna, a game console, a video cassette player, a DVD player, a video CD player, a digital video recorder, a digital video player, a hard drive, a laser disc player, a memory storage device, or any other source that broadcasts or transmits audio-video programming. The incoming audio-video broadcast from the source 232 may be transmitted via appropriate input transmission equipment 234 so as to be received at the first input port 212. The input transmission equipment 234 may include appropriate hardware and software for processing and transmitting the audio-video programming to end-users. For example, the input transmission equipment 234 for a cable television broadcast may include coaxial cable from a cable provider to the first input port 212. A satellite broadcast may be transmitted via transmitting and receiving dishes, and then converted to other transmission means, for example, a coaxial cable. The input transmission equipment 234 may include other hardware compatible with the type of the first input port 212, such as S video cables, HDMI cables, DVI cables, component video cables, VGA cables, fiber optic cables, aerial antennae, etc. The transmission equipment 234 may further include intermediary devices, such as routers, splitters, combiners, converters, etc. which serve to transmit the audio-video broadcast to the system 200. In various embodiments, the input transmission equipment 234 may include internet, DSL, satellite, LAN/WAN, Wi-Fi, Bluetooth, digital cable, digital satellite, and/or TCP/IP transmission equipment, both in the form of hardware and/or software.

The first signal 230 received at the first input port 212 comprises at least one audio-video program received from at least one source 232. The first signal 230 comprises one or more content components, including video components or streams, one or more audio components or tracks, or one or more graphics components, such as text, graphics, labels, animations, or symbols. For example, the first signal 230 may include a television program, or film, broadcast with a video stream (the visual part of the program or film), audio tracks (the audio portion of the program or film), and optionally graphics (textual overlays, graphical markers, channel labels, etc.). The first signal 230 includes at least one default component, and may optionally have a plurality of default components. For example, in the case of a television broadcast, the video component and the audio component, as produced during the creation of the audio-video programming, are default components. As used herein, “default components” refer to the audio-visual components of a program as produced by the producer, author or creator of the program. Thus, a film, for example, has default audio and video components as it originally appeared when released in theaters. A television program has default audio and video components as it originally appeared when broadcast. A recorded audio-video program played from media, such as a hard drive, a DVD, or videotape, has default components as they are recorded on such media.

It should be understood that if a program (such as a television program or film) is edited from its original version and recorded or stored on media for future playback or transmission, the edited version may still be an “original broadcast”, as such term is used herein. For example, if an “R” rated movie is edited so as to comply with television regulations (i.e. editing of the audio track to eliminate profanity to create a “TV version” of the film), when such edited TV version of the film is broadcast, it is an original broadcast which is available for further modification using the system. Stated differently, “original version” or “original broadcast” refers to the version of the program broadcast by an input source to be received by users (of traditional systems 100 and the system 200 of the present invention alike).

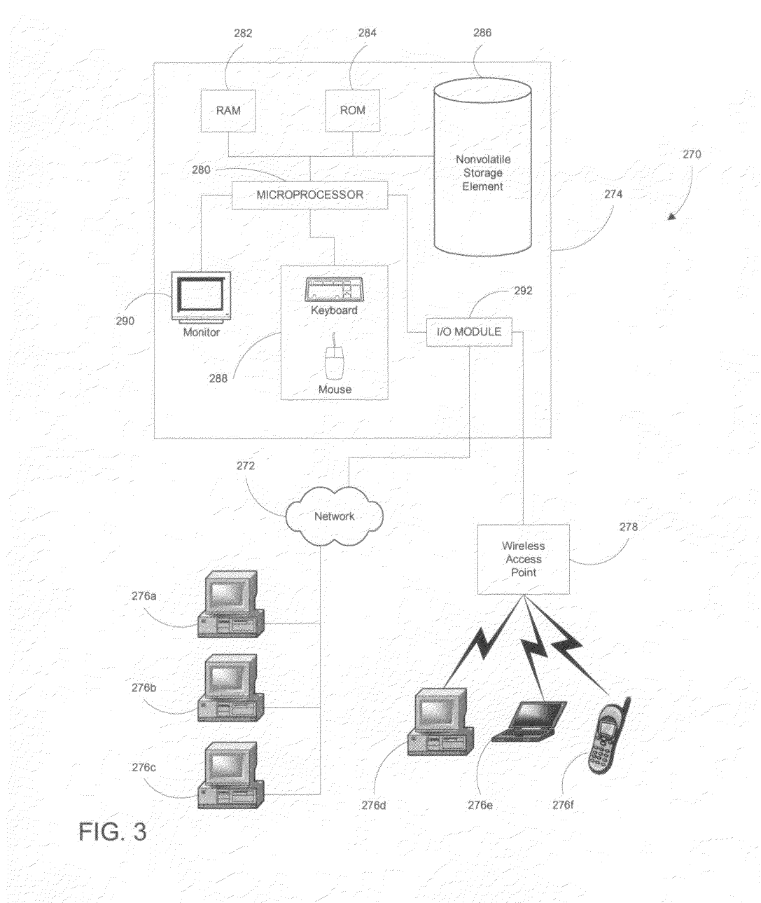

The system 200 further includes a second input port 214 for receiving a selected alternative content stream 240, chosen from a plurality of available alternative content streams 241 available from a data system 270. The second input port 214 may comprise a wired or wireless port for receiving digital communications from one or more storage media, either directly, or over a network 272. In an embodiment, the second input port 214 comprises a network port, such as an Ethernet port, or wireless port. The selected alternative content stream 240 is transmitted to the second input port 214 via the data system 270, which may include a network 272, and may further include any number of components such as storage devices, network connections, routers, hubs, and wired or wireless devices in communication with one another using one or more data transfer protocols, as described herein in greater detail with reference to FIG. 3. The selected alternative content stream 240 may include one or more components including alternative video content, alternative audio content, alternative graphics content and alternative textual content.

The system 200 further includes at least one controller 250 or processor. The controller may also be referred to herein as a central processing unit (CPU) or processor (such as a microcontroller or microprocessor). It should be appreciated that the controller 250 may include one or more microprocessors, including but not limited to a master processor, a slave processor, a dedicated multimedia processor, and a secondary or parallel processor. The controller 250 is in communication with the first input port 212 and the second input port 214, and thus receives the first signal 230 and the selected alternative content stream 240. The controller functions 250 to appropriately synchronize and combine the first signal 230 and the selected alternative content stream 240 so as to create a modified audio-video program 242. The modified audio-video program 242 comprises additional components not present in the first signal 230. The additional components may either replace one or more components in the first signal 230, or may supplement the first signal 230 in some fashion. The controller 250 may also be in communication with one or more components of system memory 254. For example, the controller 250 may be supported by system memory 254 that may include read-only memory, random access memory and a nonvolatile storage memory such as a hard drive. An input/output module may support bilateral internal communications between the controller 250 and various input and output devices.

In an alternative embodiment, the data system 270 may comprise two or more computers 276 or servers 274 connected together in a peer-to-peer network (P2P), rather than through a central server or data system. In such a configuration, a plurality of computers 276 may be interconnected so as to share files, such as alternative content streams 241. Moreover, the alternative content streams 241 available over the P2P network may be stored on all or some of the computers 276 in the network, rather than on a central server or repository. A P2P network protocol may be utilized by clients so as to allow clients to share files with one another. Thus, the peer-to-peer network offers an alternative to the network configuration having a server, such as those in FIGS. 2 and 3.

In an embodiment, the selected alternative content stream 240 may comprise at least one alternative audio track, wherein the at least one alternative audio track replaces at least one default audio track in the modified audio-video program 242. In such an embodiment, the modified audio-video program 242 no longer contains the default audio track, but rather has the replacement alternative audio track of the selected alternative content stream 240. Thus, a viewer or listener of the modified audio-video program 242 would receive a different aggregate program than a viewer or listener of the original broadcast program over the first signal 230, due to the replaced component. It should be understood that any or all of the components (audio, video, graphics, text) of the selected alternative content stream 240 may replace any or all of the components (audio, video, graphics, text) of the original program of the first signal 230.

Alternatively, the selected alternative content stream 240 may include one or more components that supplement the first signal 230. Thus, for example, a textual component or supplemental graphics component of the selected alternative content stream 240 not present in the original program of the first signal 230, may supplement the first signal 230 in the modified audio-video program 242. In such an embodiment, a viewer or listener of the modified audio-video program 242 would receive supplemental content not present in, or different from the presentation in the original program broadcast over the first signal 230. Thus, again, the overall aggregate program of the modified audio-video program 242 would be a different experience than the original broadcast program of the first signal 230. It should be understood that any or all of the components (audio, video, graphics, text) of the selected alternative content stream 242 may supplement any or all of the components (audio, video, graphics, text) of the original program of the first signal 230, or subcomponents thereof (such as a portion, element, or layer of an audio track or video stream). The modified audio-video program 242 may contain only slight changes from the original broadcast program. In one example, changes to graphics such as colors, themes, logos, etc. may be provided, for example, relating to time of day, seasons, holidays, special events, etc. Thus, the modified audio-video program 242 may be virtually identical to the broadcast program, but for the addition of specific graphics, such as a holiday themed graphic.

The controller 250 combines and synchronizes the first signal 230 and the selected alternative content stream 240, using one or more synchronization techniques. For example, the first signal 230 and the selected alternative content stream 240 may be synchronized using time markers or tags present in each signal 230, 240 and lining up such time markers or tags when creating the modified audio-video program 242. Other synchronization techniques may also be utilized. For example, a technique which may be utilized to perform such synchronization involves storing and retrieving time stamps and memory stamps, and is described in U.S. Pat. No. 6,920,181 to Porter, which is hereby incorporated by reference in its entirety as if fully set forth herein. Once the first signal 230 and the selected alternative content stream 240 are combined and synchronized by the controller 250, the modified audio-video program 242 is created and available for transmission. The modified audio-video program 242 may be stored on one or more storage devices or other media, such as the system memory 254, for later transmission. Alternatively, the modified audio-video program 242 may be broadcast by the system 200 in real time, or live.

In performing its function the controller 250 may also utilize one or more compression techniques to send and receive data from the various ports 210,260. Moreover, the controller 250 may recognize various formats of information delivered to the first and second input ports 212,214 and combine them into a single format compatible with the output port 260 and output devices 262. The controller 250 may also serve to equalize file transfer speeds received at the input ports 210, and to compensate for variations in processing speeds between the system 200 and outboard processors, so as to synthesize the signals received into a combined output signal with little or no noise, errors, or distortion.

The system 200 further includes at least one output port 260 for transmitting the modified audio-video program 242 to an output device 264. The output port 260 may be either analog or digital and may be any form of physical or wireless connection that serves to transmit the modified audio-video program 242. For example, the output port 260 may be an RF cable connector, an S-video port, an HDMI port, a DVI port, an RCA port, a digital coaxial cable port, a Y/Pr/Pb component video port, a VGA port, a fiber optic port, a D-sub port, a ViVo port, an aerial or wireless antenna or a D-connector port. The output port 260 may further be a coaxial port, an RS232 port, an NTSC composite port, or a cable off-air port. The output port 260 may also be two or more of such ports in combination. Moreover, the output port 260 may be a digital output port, such as a network connection, an Ethernet port, or a wireless network transmitter. The modified audio-video program 242 is transmitted via the output port 260 to one or more output devices 264 and may optionally use various forms of outbound transmission equipment 262. The output devices 264 may include a television, a monitor, or other display. The output devices 264 may further include audio devices such as speakers, amplifiers, or other sound transmission devices. Moreover, the output devices 264 may also include analog or digital storage or recording/playback devices, including hard drives, video cassette recorders/players, digital video recorders/players, computers, DVD recorders, CD recorders, laser disc recorders, or other memory storage devices. Outbound transmission equipment 262, if necessary, may include appropriate cabling, transmitters, routers, switches, networks, etc. to deliver the modified audio-video program 242 to the desired output device 264.

The system 200 may further include an information display 270, such as a menu system or selection display. The information display 270 may display, among other things, available alternative content streams 241 to be selected by a viewer or listener. The system 200 may also receive selection of the selected alternative content stream 240 from the available alternative content streams via the information display 270 or through other input devices, for example a remote control. The information display 270 may be part of the same equipment as the ports 212, 214 and controller 250 and housed within the housing 202 as shown in FIG. 2. Alternatively, the information display 270 may be presented via other displays in communication with the controller 250, such as through one or more output devices 264. The information display 270, instead of or in addition to a visual display, may include audio options which prompt the viewer/listener for various inputs.

Referring to FIG. 3, an illustrative data system 270 such as the data system 270 in FIG. 2, is depicted and described in greater detail. The data system 270 includes at least one server 274 and a plurality of computers 276a,b,c in communication with one another via a network 272. A bi-directional communication channel and a communication network 272 support high speed communications between the server 274 and the computers 276. A wireless access point 278 may be coupled to the server 272 to support high speed wireless communication links with a variety of stationary and mobile computers 276, such as stationary computer 276d, portable computing device 276e, e.g. laptop computer, and a personal communication device 276f, e.g. a cell telephone with data capabilities. A “stationary” computer refers to desktop type computers that remain fixed during use by a user. A “mobile” computer refers to a computer contained in a portable apparatus that can be transported by a user during and in between use. For example, a mobile computer machine could include a laptop computer with wireless capabilities, a personal digital assistant with wireless capabilities, a cellular telephone with appropriate input and output capabilities, etc. Each of the computers 276a-f may include hardware or software which identifies the device, or the user of the device, such that other users of the data system 270 can identify the source of the content, and from where it was received (for example, an IP address).

The server 274 includes a nonvolatile storage resource 286 such as for storing configuration data used by the server, application software and alternative content stream data. A microprocessor 280 performs processes and tasks based on stored program instructions. It is supported by read-only memory (ROM) 282, random access memory (RAM) 284 and nonvolatile data storage device 286. As will be understood by those skilled in the art, data and stored program instructions in ROM 282 is typically utilized by microprocessor 280 to initialize and boot the computing apparatus. An application program, e.g. a program that controls the implementation of one or more functions performed by the server 274, is stored in storage element 286. At least active portions of the application program will be typically stored in RAM 284 for ready access and processing by microprocessor 280. A variety of user inputs 288 such as a keyboard, keypad, and mouse can be utilized to control the operation of the server and applications running on it. A display screen 290 provides a visual output for an administrator or user of the server 274, and an optional audio output device may be utilized. An input/output (I/O) module 292 provides a communication interface permitting microprocessor 280 to transmit and receive data with the computers 276 and other devices over the network 272. As will be described in detail herein, the server 274 generates, stores, and provides a plurality of available alternative content streams which can be received by the system 200 of FIG. 2 via the second input port 214.

The storage element 286 of the server 274 of the system 200 can be used to store, organize, and make available the plurality of alternative content streams 241. These alternative content streams 241 may be created and received at any of the computers 276 of the data system 270, which may communicate with the server 274 via the network 272, which may include communication over the Internet. Thus, users of the computers 276 may create alternative content streams 241 which may be uploaded to the server 274 via the data system 270, where they may be stored, categorized and made available for transmission to the system 200, as described in greater detail herein. The storage element 286 may also be permitted to communicate with local storage, such as the memory 254 of the system 200, so that alternative content streams 241 may be stored in one or both locations.

Like the server 274, each of the computers 276 can include one or more microprocessors, memory, storage devices, and input devices. In an embodiment, one or more of the computers 276 includes a microphone for receiving audio content to be utilized in creation of one or more alternative content streams 241. Other input devices could include a keyboard or mouse for receiving selections, and for inputting textual information utilized in one or more alternative content streams. Yet other input devices could include video or still cameras or other photography equipment for capturing video information to be utilized in creation of the alternative content streams 241. Moreover, the computers 276 may include various graphics editors or other software for creation of graphics, text, video, or audio which can form portion of alternative content streams 241 uploaded to the data system 270.

In an embodiment, one or more of the computers 276 or the data system 270 itself may include a content creation tool to assist users of the computers 276 to create alternative content streams 241. The content creation tool may be a software tool, a hardware tool or input device, or a combination of both, which is used in conjunction with the computer 276 to create, edit, format, and upload alternative content streams 241 to the data system 270. For example, the content creation tool may be a software tool which prompts users to add components such as audio tracks, video streams, graphics, and textual inputs to create alternative content. The tool may use logical graphical layouts, drag and drop input techniques, or other software assistance to make creation of alternative content simpler. Video production software and audio recording software are examples of software which may be integrated into such a content creation tool. The content creation tool may interface with input devices such as cameras and microphones so as to seamlessly receive content components to be mixed, synthesized and produced into one or more alternative content streams 241. The computers 276 may store components of the alternative content streams 241 in memory, as well as storing the completed stream 241 prior to, during, and after uploading the completed stream 241 to the data system 270.

Moreover, one or more of the computers 276a-e or the data system 270 itself may further include conversion equipment to allow conversion of content input into the system in one format, into a second format to be used in one or more alternative content streams 241. For example, conversion software and/or hardware resident on a computer 276a-e may permit text entered into the computer 276a-e to be converted to speech or other audio which is then used as part of an alternative content stream 241 transmitted to the system 270. In this way, a producer of an alternative content stream 241 may utilize one form of input to achieve a component having a different format in the completed alternative content stream 241. In another example, speech recognition software may be utilized to receive a spoken audio feed into the computer 276 and convert the speech to text which is then used as a component of the alternative content stream 241. Other conversion tools may be used, including shorthand, language transcribers, text to speech converters, speech to text converters, etc. In this way, any input into one or more of the computers 276a-e can be converted into a different input format to be used as part of the system 200.

The system 200 of FIGS. 2 and 3 can be utilized in a number of manners to provide alternative content to audio-video programming received from input sources 232. In an embodiment, persons can utilize the system 200 to create alternative content that can be stored on and made accessible through the data system 270. Viewers of particular audio-video programming may desire to receive information instead of, or in addition to, the information contained in default components of an audio-video broadcast transmission. Thus, the system 200 described herein may be utilized to provide viewers with a universe of alternative content streams 241 which provide a diverse set of audio, video, graphical and textual elements to customize the watching of the audio-video programming.

For example, television viewers and other persons not associated with the producer of an audio-video program may create supplement or replacement content via the data system 270. In an embodiment, a viewer of a program may record a supplement audio track, add audio or speech effects, create additional graphic overlays containing supplemental information, or may record a supplement video presentation containing additional information about the broadcast. Such supplemental content stored on the server 274 is made available to other viewers through the system 200. Thus, if the supplemental content is selected by a viewer, it can be downloaded via the second input port 214 and broadcast as part of the modified audio-video program.

One example of such use of the system 200 relates to broadcasts of sporting events on television, for example a professional football game. The original broadcast of the game is usually accompanied by default audio (play by play commentary by the networks paid broadcasters), default graphics and text overlays (as provided by the network producing the game broadcast), and default video (as captured by the networks cameras and edited and produced into the broadcast). However, the information broadcast in such default components may not be properly tailored to all viewers. For example, a football novice may find the audio commentary and graphical information too confusing. An extreme football fan may find the default audio commentary and graphical information insufficient. Fans of one of the teams involved in the game may prefer information more tailored to their team, while fans of the other team would not. Viewers interested in particular portions of the sporting event may desire a different camera angle, view, or perspective, for example a handheld video camera from a viewer in the audience at the sporting event. In other words, customized content would be highly desirable. In such an example, the system 200 provides access to such alternative content for customization.

For example, a fan of the Chicago Bears may routinely watch Bears games and record supplemental audio, create supplemental graphics, or record supplemental video containing additional information highly desirable by Bears fans and provide such information on the data system 270 in the form of one or more alternative content streams 241. Such supplemental content, in an embodiment, is recorded via one or more input devices of one or more computers 276 of the data system 270, and stored on the storage media 286 of the server 274. When a fan of the Chicago Bears is watching a Bears game, he receives the program via the first signal 230 from an input source 232 (i.e. a cable TV provider). He then may select to receive an alternative content stream 240 having Bears-specific supplemental content, for example, play by play by a well known Chicago Bears sports broadcaster. Such a viewer may then customize his experience by viewing a modified audio-video program 242 in which the alternative content stream 240 supplements the default program received via the first signal 230. In an embodiment, the viewer can have the custom audio track replace the default audio track so that he watches the broadcast football game while listening to the alternate audio play by play. Alternatively, the viewer could rewind and replay portions of the program one or more times to hear several versions of audio commentary accompanying the presentation. In another embodiment, the alternative content stream 240 supplements rather than replaces the default components, for example, additional graphics or statistics that overlay the program as displayed.

Many other examples exist as to how the system can be utilized to combine and synchronize an alternative content stream 241 with a program received via the first signal. A musical performance of a symphony or a reality television show with audience voting or feedback may be supplemented by textual commentary from a plurality of viewers who input their comments to the data system 270 via the computers 276 therein. Such viewers may provide their commentary via their home computers, or mobile devices, which transmit the text over the network 272 where it can be forwarded to other viewers via the system 200. Such text, and other alternative content, may be transmitted in many well known formats, including e-mail, instant messaging, text transfer protocols, SMS format, FTP transfers, etc. A television broadcast of fireworks on the Fourth of July which contains no audio, or undesirable audio, may be modified by combining and synchronizing alternative audio from the data system 270 so a viewer could experience the modified audio-video program 242 via one or more output devices 264. Alternatively, text messaging amongst viewers may overlay a portion of the display during the fireworks presentation.

In another example, in a major league baseball contest between the Los Angeles Dodgers and the Chicago Cubs played in Chicago, a Dodgers fan living in the Chicago area would traditionally only be able to listen to the default audio commentary as broadcast. Thus, the Dodgers fan may not be satisfied with listening to the biased commentary of the Chicago announcers who may favor the home team. The system 200 could be utilized to locate and stream in a selected alternative content stream 240 having play by play commentary from a Los Angeles based announcer, which the Dodger fan may prefer. Moreover, the Dodger fan may want alternative statistics or other textual information other than those provided in the default broadcast. The system 200 could be utilized to receive such statistics from the data system 270 and display them on the output device 264 as part of the modified audio-video program 242. The Dodger fan may also want to read commentary about particular players, plays, pitches, and other features throughout the game. Thus, the system 200 can be utilized even further to receive streaming text commentary from well known sports analysts, fans, friends, family members, etc. The customization options offered by the system 200 are limited only by the diversity of alternative content streams 241 available on the data system 270.

The availability of the plurality of alternative content streams 241 also allows customization of the viewing experience for viewers having different skill levels, experience with the programming content, or other parameters. For example, in the example of a professional football game, viewers may prefer to hear audio commentary which is biased in favor of their team, a comedian who makes them laugh or makes fun of the opposing team, a particularly articulate commentator not employed by the broadcast network, a person with particular knowledge or history of a player or aspect of the event, a person, company or organization capable of sharing relevant statistics, a trusted source, an astute fan with superior knowledge of rules, a fan voted or acknowledged by other viewers as providing entertaining or superior content, etc. A viewer may also change his desired alternative content stream 240 several times throughout a broadcast. For example, if his sports team is winning he may favor a commentary by an articulate sports commentator, but may switch to a comedian poking fun at the opposing team, once his team starts losing.

The system 200 may be further utilized to provide alternative content streams 241 associated with fantasy sports leagues, particular aspects of a sports presentation (offense, defense, etc.), or even particular favorite players within the sports contest. For example, one or more alternative content streams 241 may offer commentary directed at the effect of a particular player's performance on fantasy football scores, points, and performance. Other alternative content streams 241 may focus on different players or competitors based upon viewers' selections. A large variety of expertise levels, experience levels, focuses, and other customizations (such as languages) may be offered in the variety of alternative content streams 241 available.

The creation of the alternative content streams 241 may occur live or in “real time”, such as a viewer watching a particular broadcast inputting textual commentary via the data system 270. Alternatively, the creation of the alternative content streams 241 may occur at other times, such as after a broadcast is received and recorded. A viewer may go back and add commentary, audio, graphics, text, etc. to create an alternative content stream that is later stored on the data system 270. Similarly, the coupling and synchronization of a selected alternative content stream 240 with the first signal 230 may utilize live time content, or may be pre-recorded. For example, a viewer of a football game may watch the event as it is broadcast in an unmodified state, or may listen live in real-time or near real-time to an alternative content stream 240 having a replacement audio track. In an embodiment, a viewer may record the first signal 230 via the memory 254 of the system 200, and replay and re-watch a desired program multiple times. During each replay of the event or program, the viewer may utilize or switch between different alternative content streams 241 available for the program so as to get a different experience through each modified audio-video program 242. Thus, a replayed event may provide a fresh experience through the synchronization of fresh alternative content, once or many times.

In another example, a political program, such as presidential debate among various candidates, may be supplemented by commentary and other information in the form of text, graphics, video, and audio content. Such alternative content streams 241 may be selected so that a viewer can experience customized content from someone in their desired political party, a neutral observer, or others with different perspectives on the political issues featured in the debate. Thus, the system 200 provides the ability to customize the alternative content streams 241 to experience a modified audio-video program 242 having desired parameters.

In other embodiments, the producers of an audio-video program themselves may utilize the data system 270 to provide various customizable components of the program. For example, such producers may offer alternative content streams 241, such as a plurality of announcers, hosts, or commentators, providing commentary on the same visual event (a sports program, the Emmys, the Academy Awards, an entertainment program). A viewer of the program could then utilize the system 200 to receive one or more of the alternative content streams 241 provided, and could even switch between the various available alternatives to receive different viewing experiences throughout the broadcast. Thus, in an embodiment, the suppliers of the alternative content streams 241 may be viewers, producers of original broadcasts, or other third parties. In an example, television producers broadcasting a horse race such as the Kentucky Derby may employ several announcers, and perhaps even one announcer for each horse entered in the race. Each such announcer may provide commentary specific and unique to that horse, such that a viewer who has a particular interest in a horse (perhaps a horse on which he has placed a wager) may experience audio commentary which is customizable. The producer of such a program may broadcast one or more of such audio tracks as part of the original programming, and make others of such audio tracks available as alternative content streams 241 which may be used to supplement or replace all or portions of the broadcast audio tracks. Moreover, if the produced broadcasts a plurality of audio tracks over the first signal 230, there may not be a “default” audio track, in an embodiment. Instead, a viewer selection of a default audio track (from a plurality of available broadcast audio tracks) may be required. In an alternative embodiment, if no selection is received, or after a predetermined amount of time, one of the available audio tracks may be selected by the producer as a default audio track.

Thus, in such an example, a viewer may use the system 200 of the present invention to view the video of the original broadcast over the first signal 230, while listening to several audio tracks corresponding to various horses in the Kentucky Derby Race. Moreover, the viewer can change between the different audio streams throughout the racing event. For example, if the horse in which the viewer was originally interested falls to the back of the pack, the viewer may change his or her selection of the audio track, such that the modified audio-video program 242 is altered to provide a different audio track. As stated before, one or more of the audio tracks corresponding to announcers associated with particular horses may appear as original audio tracks and one or more audio tracks of other announcers (corresponding to other horses) may be available to the viewer as alternative content streams 241. In this way, the system 200 can be utilized to save bandwidth on the first signal 230 by allowing a produced of a program or input source 232 to provide a wide variety of content, some of which is delivered over the first signal 230 and the remainder of which is available as alternative content streams 241.

In other examples, players on sports teams may be fitted with microphones while engaged in the sporting event. Alternatively, race cars may be equipped with cameras and microphones to provide viewers and inside the cockpit experience. A producer of programming of such sporting events produces a televised version of the event by making selections of when to change from one camera to another, or when to change from one audio feed or microphone to another. In an embodiment, all of the captured video, audio and graphics may be sent to the data system 270 where it is available to be utilized in creating alternative content streams 241. Thus, a viewer could customize his viewing experience even further by not being limited to the production version of the sporting event. For example, fans of a particular race car driver may choose to view a modified audio-video program 242 which includes audio from their favorite driver's microphone rather than continue to listen to the commentary of the network anchors.

The plurality of available alternative content streams 241 may be stored and organized on the server 274 utilizing a large variety of techniques, and may be accessed or sorted using a large variety of filtering mechanisms. For example, the alternative content streams 241 may be sorted into groups or “channels” based upon different parameters, such as author, affiliation, genre, personal rating, group rating, skill level, experience level, favorites rating, popularity rating, and content focus. The alternative content streams 241 may also be identified and organized according to the IP address from which they were received, or by identify of author, screen name, pseudonym, cell phone number, time and/or location of input or creation, format created in, etc. Other channel categories may be utilized as well. Moreover a viewer may be permitted to access, create, update and modify the channels so as to create custom groupings of alternative content streams 241. In another embodiment, the content streams 241 may be sorted based upon the components contained therein (i.e. alternative audio, alternative video, alternative text/graphics, etc.). A viewer may also be permitted to maintain a “My Favorites” channel in which one or more favorite alternative content streams 241 are stored for easy access. The data system 270 may further employ software to create custom “smart” categories, such as “most viewed”, or “most accessed” or “recently accessed” alternative content streams 241. Playlists, folders, or other devices to create organized hierarchies may be utilized. The data system 270 may further include software which tracks usage such that it may make recommendations of alternative content streams 241 to users based upon a variety of criteria it tracks. Any number of parameters may be used by which to sort, organize, and categorize alternative content into channels or groups, and to display such available alternative content streams 241 to a viewer via the information display 270. Moreover, a viewer may be able to search the data system 270 to find desired alternative content streams 241. The searches may be text input into searching software, but may also be searches based upon graphics, video or audio which is input into the data system 270 and compared to existing alternative content streams 241 for matching content.

In another alternative embodiment, the alternative content streams 241 may comprise audio, textual or video dialogs between or among a plurality of viewers, either in real-time, near real-time, or played back from recordings. For example, a first viewer and a second viewer may input text commentary that is combined into a single stream of alternative content and then displayed in conjunction with a default audio-video presentation to create the modified audio-video program 242. In an alternative embodiment, a plurality of alternative content streams 241 may be utilized to deliver the dialogue or interaction among the plurality of viewers. Thus a viewer of the modified audio-video program 242 can see a back and forth discussion between the first viewer providing commentary and the second viewer responding thereto. Similarly, a group of viewers may input commentary into a pool or peer group, and the alternative content stream 241 may comprise the aggregate discussion or commentary by the group of viewers. Moreover, the system 200 can be utilized to provide instant messaging between friends watching a common program broadcast from an input source. In this way, the system 200 can serve to provide alternative content in the form of several additional inputs simultaneously, such as in the form of a discussion group. This embodiment of the invention provides an incentive for viewers to continue discussions, for example, even through television commercials such that advertisers and television program producers benefit from additional viewership during those times. In this way, the system 200 may be used to counteract the effects of devices such as digital video recorders which allow viewers to avoid and bypass commercials. Many other features of instant messaging may be employed with the system 200 with such text exchanges. For example, chatters can create profiles, choose to be visible or invisible to others, initiate conversations, accept or decline invitations for conversations, maintain buddy lists and groups of friends to chat with, receive notification of other chatters being available and online, etc.

It should be understood that alternative content streams 241 may further contain graphics, including stationary graphics, or animations. In one embodiment, the content may include digital illustrations, such as the use of a “telestrator” commonly used to highlight or identify relevant portions of the video display during sporting events (for an example, see www.telestrator.com). In another embodiment, the graphics may include text, charts, banners, scrolling words, numbers, or other alphanumeric information. In yet other embodiments, the graphics may include logos, artwork, or other customized graphics, which may be associated with the alternative content stream 241, to either provide information, provide thematic decoration, or perhaps to even convey authorship, affiliation, expertise level, geographic significance, and other such relevant information to viewers about the alternative content stream 241.

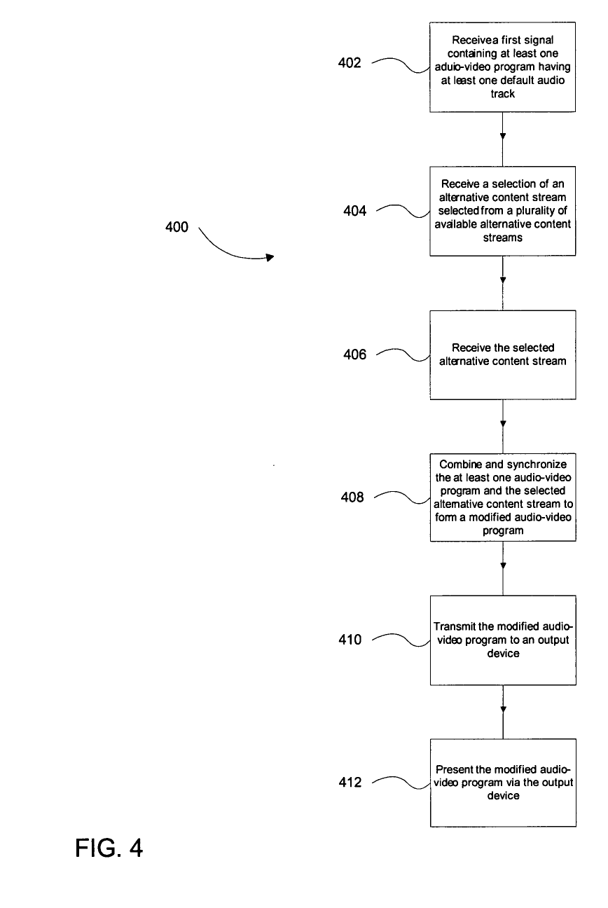

In FIG. 4, a method 400 for modifying and presenting audio-video content is shown. At step 402, a first signal is received containing at least one audio-video program, the at least one audio-video program having at least one default audio track associated therewith. The at least one audio-video program may have other components, such as other audio tracks, a video stream, graphics, or text. At step 404, a selection of an alternative content stream is received, the selected alternative content stream selected from a plurality of available alternative content streams. This selection may be received from any viewer or listener. At step 406, in response to selection, the selected alternative content stream is received. In an embodiment, the selected alternative content stream is received from a data system in a digital format. In other embodiments, the selected alternative content stream may be received from any number of sources and in a number of formats. At step 408, the at least one audio-video program and the selected alternative content stream are combined and synchronized to form a modified audio-video program. At step 410, the modified audio-video program is transmitted to an output device. At step 412, the modified audio-video program is presented via the output device.

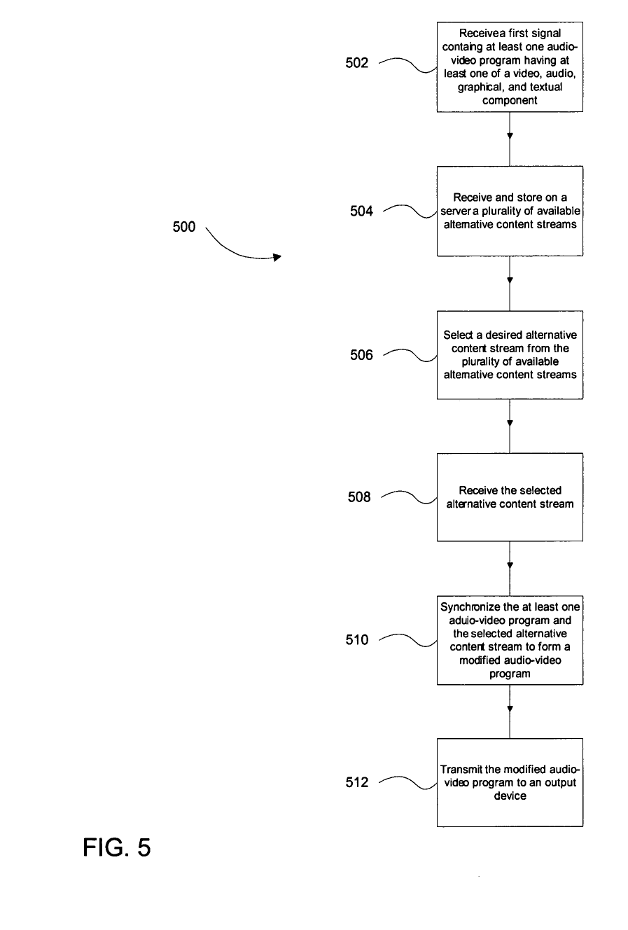

In FIG. 5, a method 500 for modifying audio-video content is shown. At step 502, a first signal containing at least one audio-video program is received. The at least one audio-video program has at least one of a video component, an audio component, a graphical component and a textual component. At step 504, a plurality of available alternative content streams are received and stored on a server. One or more of the alternative content streams are associated with the at least one audio-video program. For example, in one embodiment, a software tag is used by a creator of the alternative content stream to label and associate it with the original audio-video program with which it is intended to be replayed (the original program which it modifies). Each of the alternative content streams has at least one of a video component, an audio component, a graphical component and a textual component. At step 506, an alternative content stream is selected from the plurality of available alternative content streams. At step 508, the selected alternative content stream is received. At step 510, the at least one audio-video program and the selected alternative content stream are synchronized to form a modified audio-video program. In an embodiment, the synchronization is performed by a controller, such as the controller of the system 200 in FIG. 2. At step 512, the modified audio-video program is transmitted to an output device.

In alternative embodiments, the original programming provided to the system 200 may be received from one or more sources 232 in a digital format, such as digital video and audio, using known formats such as MPEG, AVI, etc. Thus, the first signal 230 may be either digital or analog. In other alternative embodiments, it should be understood that the entire system 200 may reside on a mobile, portable, or handheld device, such as mobile electronic unit. In such a configuration, the original broadcast received over the first signal 230 may be received wirelessly. Moreover, the supplemental content, such as text, may be inputted and created on the mobile device, and may be transmitted wirelessly to the data system 270, where it is integrated into one or more alternative content streams 241, which may be synchronized with the original broadcast to create the modified audio-video program 242. Thus a viewer of a display on the mobile device could enter text which is uploaded to the data system 270, stored in an alternative content stream 241, and combined for an experience that includes live time text commentary by the viewer, and optionally other persons having access to the data system 270.

As used herein, the term “audio” refers to one or more tracks of audio content, or subcomponents thereof. Thus, a first signal 230 received from an input source 232 may have audio components which are organized and delivered on one or more tracks which may be individually delivered and transmitted, or may alternatively be mixed together in groups of sub-mixes, or a master mix. The audio delivered through the first signal 230 may be completely replaced by audio from a selected alternative content stream 241. Alternatively, the audio in the first signal 230 may be modified by the alternative content stream 241, such that portions of audio are added to or deleted from (masked, for example) the original audio tracks to enhance the listening experience. Subcomponents of the audio tracks may include sound effects, music, dialogue, etc. Moreover, these subcomponents may be organized in various tracks so as to be delivered in various formats appropriate for various output devices 264. For example, the audio tracks may comprise audio information which is delivered in formats such as surround sound, high definition audio or 3D audio. Thus, it should be understood that in an embodiment, the audio of a modified audio-video program 242 may be similar, or even contain all of the audio content from the first signal 230, and may differ only in supplemental audio material, such as sound effects, combined with or layered over the original audio. Thus, in an embodiment, the modified audio-video program 242 may be very similar to the original audio-video program received via the first signal 230, with only minor additions, edits, changes, deletions, etc.

In an alternative embodiment, the output device 262 may also contain multiple video feeds. For example, in an embodiment, a television output device 262 may display a split video screen, or a screen having a plurality of video programs each displayed within a unique window on the screen. The windows can be organized on the screen of the output device 262 in any appropriate manner, including tiling of the windows so that all are visible at once, or overlaying portions of windows over portions of other windows, such as with “picture in picture” viewing. One or more of the windows on the screen of the output device 262 may be used to display original broadcast programs, and one or more of the windows on the screen of the output device 262 may be used to display various modified audio-video programs 242. Thus, several combinations are possible. A viewer can watch a side-by-side version of an original program and a modified audio-video program 242 so as to be able to experience and compare the differences provided by the modifications. Moreover, a viewer may choose to simultaneously view two or more different modified audio-video programs 242 so as to be able to compare them, perhaps to select from among the group. For example, the windows could be used when a political debate is broadcast. A viewer can watch the original program as broadcast by a television provider, and simultaneously watch a second version of the program with commentary from a Republican commentator, and still simultaneously watch a third version of the program with commentary from a Democratic commentator.

In yet another alternative embodiment, the original audio-video program received over the first signal 230, and the modified audio-video program 242 may both be organized using various layers or zones of video content. Thus, a television program received from a cable television provider, for example, may have the screen of video content divided into a plurality of zones (distinct or overlapping adjacent areas of the screen), or layers (distinct overlying translucent layers which can be seen, either partially or entirely, through one another). This allows a producer of a television program to designate distinct areas of the video feed to be used for receiving alternative content via the alternative content streams 241. In one example, a producer of a sports news program may designate a portion on the lower right hand corner of the display as the place where updated scores are posted to viewers. A viewer who has previously recorded a sporting event but not yet had an opportunity to view the program may not wish to know the outcome yet. However, that viewer may still wish to watch the sports news program. Such a viewer may utilize a selected alternative content stream 242 to replace the scoreboard “zone” on the lower right hand corner of screen so that he may still view the sports news program without risk of seeing the score of the game he has recorded but not yet watched.

Thus, the modified audio-video program 242 may also be used to effectively “delete” portions of the original program of the first signal 230, by replacing such components with alternate elements. In the case of video, textual or graphical elements, the original elements may be “deleted” by being replaced with alternate video or graphics, or even blanks. In the case of audio elements, the undesirable audio components may be “deleted” by being removed entirely and replaced with silence, or by being replaced with alternative audio content, such as music. Layers can be utilized in a similar fashion such that certain portions of a program are assigned to certain identified layers. In turn, a producer of a modified audio-video program 242 may assign portions of the alternative content stream 242 he creates to be on the same identified layers. Then, a rule set stored in memory 254 may be used by the controller 250 to process the components of the original program of the first signal 230 and the selected alternative content stream 242 so that the original, replacement, and supplemental portions of each appear on the correct layers (or zones) in the modified audio-video program 242.

The system 200 may further include a variety of security measures which are used to receive, authenticate, and allow modification to the first signal 230 and the available alternative content streams 241. For example, hardware or software authentication may be required to receive the first signal 230 from an input source 232. This authentication can be utilized instead of, or in addition to, a set-top box configuration where the components of the system 200 are located in a housing 202. In one embodiment, a cable card, a smart card, a USB device, a dongle, a chipset, or any other authentication device may be employed by the system so as to have proper permission and authentication to receive programming via the first signal 230. Other authentication devices may be used, including a biometric identifier, a memory stick, or other storage device which is associated with an authentication code used and compared against a security code transmitted from the input source 232 so as to verify permission to receive the transmission. Similarly, authentication and security can be utilized with the second signal received at the second input port 214. Digital certificates, public key/private key technology, or other authentication, security and/or encryption techniques may be used to confirm permission to receive alternative content streams 241 into the system 200.

As used herein, the term “real time” should be understood to mean both actual real time, or “live” transmission as well as “near real time”, where in the transmission has some small but acceptable lag or delay. If a viewer has selected to receive an alternative content stream 240 comprising an alternative play by play announcer of a live football game, limitations of the hardware and software technology may inherently cause a slight delay between the time a live event in the sporting event occurs, and the alternative content stream 240 is delivered. For example, if a kicker attempts and successfully scores a field goal kick in the football contest, because the alternative content provider's announcer first must view the successful attempt, then provide his audio commentary, which is uploaded to the data system 270, transmitted to the second input port 214, processed and synchronized with the first signal 230 by the controller 250 and then delivered to the output device 262. In some cases, regardless of the speed and efficiency of the hardware and software equipment, a slight delay may occur. The system 200 may compensate for this by delaying or slowing down the display of the modified audio-video program 242 to compensate for the delay. For example, even though the original video of the field goal kick is received at time X, the controller 250 may delay display of the modified audio-video program 242 by two seconds, for example, if there is a two second delay in the creation and reception of the selected alternative content stream 240 required to create the modified audio-video program 242. This time shifting technique may be accomplished by hardware or software in communication with the controller 250, including the memory 254 and other devices.

It should be understood that a producer or other input source 232 may broadcast an “original” program that was previously created and presented as a modified audio-video program 242. For example, during or after the broadcast of an episode of the television show “The Sopranos” on the HBO network, executives discover that a particularly entertaining alternative content stream 241 has been uploaded to the data system 270. Perhaps that alternative content stream 241 has particularly insightful trivia about the actors in the scenes, or commentary of the relationship of the scenes being shown with prior episodes of the television show. The executives at HBO may obtain the rights, if necessary and desirable, to the alternative content stream 241 and the resulting modified audio-video program 242 created when it is combined with the original episode. Thus, after licensing the rights to the modified audio-video program 242, HBO re-broadcasts the episode containing the modifications of the textual commentary. Such a re-broadcast is an “original broadcast” within the meaning of this specification because it is received as a single program by a viewer from an input source 232 without further modification. Of course, even when re-broadcast in its modified form, such an “original” program may be further modified using the system 200 and method 400, 500 herein to create even further modified audio-video programs 242. For example, another alternative content stream 241 may provide counter-commentary to the commentary contained in the re-broadcast “original.”

The system 200 and methods 400, 500 of the present invention offer a number of benefits over traditional systems for displaying audio-video programming. First of all, the present invention permits disassociation or separation of the various components (audio, video, text and graphics) of audio-video programming, and the replacement or supplementing of such components with alternative content streams. Such alternative content streams can offer a wide variety of customizable components of audio, video, text and graphics with which a modified audio-video program is created by synchronizing such alternative content streams with the original broadcast programs. In this way, viewers using the system 200 are permitted to customize their viewing experience by receiving additional perspectives and information not available from the original producers of the programming. This permits viewers to have different options to achieve a unique and enjoyable viewing experience, as well as gives viewers incentive to watch programming which may have been previously undesirable, or to re-watch programming multiple times with different alternative content each time. The invention allows viewers to remain interested and interactive in the programming by interacting with other viewers (using messaging, for example), to be creative by inputting or creating their own alternative content, and to experience programming in a variety of different and customizable manners. Thus, the overall result is an improved viewing experience.

Each of these embodiments and obvious variations thereof is contemplated as falling within the spirit and scope of the claimed invention, which is set forth in the following claims.

What is claimed is:

1. A system for presenting audio-video programming with alternative content, comprising:
a first input port for receiving a first signal containing at least one audio-video program, the at least one audio-video program having at least one default component associated therewith;
a second input port for receiving a selected alternative content stream, the selected alternative content stream selected from a plurality of available alternative content streams;
a first output port for transmitting a modified audio-video program to an output device; and
at least one controller in communication with the first input port, the second input port and the first output port;
the at least one controller operative to (i) synchronize the at least one audio-video program and the selected alternative content stream to form the modified audio-video program and (ii) transmit the modified audio-video program via the first output port.

2. The system of claim 1, wherein the first input port, the second input port, the first output port and the at least one controller are housed within a single unit selected from the group consisting of a set top box, a television, a monitor, a display, an interface board, an interface box, and an audio playback device.

3. The system of claim 1, wherein the at least one default component is a default audio track, wherein the selected alternative content stream comprises at least one alternative audio track, wherein the at least one alternative audio track replaces or supplements at least a portion of the at least one default audio track in the modified audio-video program.

4. The system of claim 1, wherein the at least one default component is at least one of a default video stream and a default audio track, wherein the selected alternative content stream comprises at least one of a graphics presentation and a textual presentation, wherein the at least one of a graphics presentation and a textual presentation supplements the at least one of a default video stream and a default audio track.

5. The system of claim 1, wherein the selected alternative content stream is selected from the group consisting of alternative video content, alternative audio content, alternative graphic content and alternative textual content.

6. The system of claim 1, wherein the first input port comprises one or more of an RF cable input, an S-video port, an HDMI port, a DVI port, an RCA port, a digital coaxial cable port, a Y/Pr/Pb component video port, a VGA port, a fiber optic port, a D-sub port, a ViVo port, an aerial antenna and a D-connector port.

7. The system of claim 1, wherein the first signal is received from a source selected from the group consisting of a cable television broadcast, a digital satellite broadcast, a satellite television broadcast, an aerial antenna, a game console, a video cassette player, a DVD player, a video CD player, a digital video recorder, a digital video player, a hard drive, a laser disc player, and a memory storage device.

8. The system of claim 1, wherein the second input port comprises a network port for receiving the selected alternative content stream in a digital format.

9. The system of claim 8, wherein the second input port is in communication with a computer network.

10. The system of claim 1, wherein the modified audio-video program is transmitted to a television, a monitor, or a display.

11. A method for modifying and presenting audio-video content, comprising:
receiving a first signal containing at least one audio-video program, the at least one audio-video program having at least one default audio track associated therewith;
receiving a selection of an alternative content stream, the selected alternative content stream selected from a plurality of available alternative content streams;
receiving the selected alternative content stream;
synchronizing the at least one audio-video program and the selected alternative content stream to form a modified audio-video program;
transmitting the modified audio-video program to an output device; and
presenting the modified audio-video program via the output device.

12. The method of claim 11, further comprising displaying the plurality of available alternative content streams.

13. The method of claim 11, wherein the selection is received from a viewer of the modified audio-video program.

14. The method of claim 11, wherein the selected alternative content stream is delivered over a network, wherein the network comprises at least one storage device, wherein the plurality of available alternative content streams are stored on the at least one storage device.

15. The method of claim 14, wherein the network includes a plurality of input devices through which the plurality of alternative content streams are received, created or uploaded.

16. A computer readable storage medium encoded with instructions for performing the method of claim 11.

17. A method for modifying audio-video content, comprising:
receiving a first signal containing at least one audio-video program, the at least one audio-video program having at least one of a video component, an audio component, a graphical component and a textual component;
receiving and storing on a server a plurality of available alternative content streams, each of the alternative content streams associated with the at least one audio-video program, each of the alternative content streams having at least one of a video component, an audio component, a graphical component and a textual component;
selecting an alternative content stream from the plurality of available alternative content streams;
receiving the selected alternative content stream;
synchronizing the at least one audio-video program and the selected alternative content stream to form a modified audio-video program; and
transmitting the modified audio-video program to an output device.

18. The method of claim 17, further comprising replacing or supplementing the at least one of a video component, an audio component, a graphical component and a textual component of the audio-video program with the at least one of a video component, an audio component, a graphical component and a textual component of the alternative content stream.

19. The method of claim 17, further comprising storing at least one set of preferences associated with a first viewer, wherein the selected alternative content stream is selected from a sub-set of the plurality of available alternative content streams, each member of the sub-set having characteristics satisfying criteria of the at least one set of preferences.

20. The method of claim 19, wherein the characteristics are selected from the group consisting of authorship, personal rating, group rating, skill level, experience level, favorites rating, popularity rating, and content focus.
